(19) United States
(12) Patent Application Publication
(10) Pub. No.: US 2015/0160611 A1
(43) Pub. Date: Jun. 11, 2015

(54) HOLOGRAPHIC DISPLAY

(71) Applicant: SAMSUNG ELECTRONICS CO., LTD., Suwon-si (KR)

(72) Inventors: Hoon SONG, Yongin-si (KR); Hong-seok LEE, Seongnam-si (KR); Kyu-hwan CHOI, Yongin-si (KR)

(73) Assignee: SAMSUNG ELECTRONICS CO., LTD., Suwon-si (KR)

(21) Appl. No.: 14/340,816

(22) Filed: Jul. 25, 2014

(30) Foreign Application Priority Data
Dec. 6, 2013 (KR) 10-2013-0151709

(51) Int. Cl. G03H 1/00; G03H 1/22; G03H 1/08

(52) U.S. Cl. CPC G03H 1/0005; G03H 1/0866; G03H 1/2294; G03H 2001/0088

(57) ABSTRACT

A holographic display is provided. The holographic display includes a support plate that is rotatable based on a rotary axis; a plurality of spatial light modulators arranged on the support plate at same distances from the rotary axis; a light source supplying light to the plurality of spatial light modulators; an optical path conversion device for guiding light emitted from the light source to the plurality of spatial light modulators; an image signal input device for inputting holographic image signals to the plurality of spatial light modulators; and an imaging area on which images by the plurality of spatial light modulators are displayed so that three-dimensional (3D) images may be displayed in all directions according to the rotation of the support plate.

### RELATED APPLICATIONS

This application claims priority from Korean Patent Application No. 10-2013-0151709, filed on Dec. 6, 2013, in the Korean Intellectual Property Office, the disclosure of which is incorporated herein in its entirety by reference.

### BACKGROUND

1. Field

Methods and apparatuses consistent with the exemplary embodiments relate to holographic displays, and more particularly, to holographic displays having a viewing angle of 360°.

2. Description of the Related Art

Recently, the development of three-dimensional (3D) movies has increased, and accordingly, research into technologies involving 3D image displays has been actively conducted. 3D image displays display 3D images based on binocular parallax, and accordingly, 3D image displays which have been recently commercialized, use binocular parallax, that is, respectively provide a left eye and a right eye of a viewer with left eye images and right eye images having different viewpoints to allow the viewer to experience a stereoscopic effect. The 3D image displays may be classified as glasses-type 3D image displays requiring special glasses and non-glasses-type 3D image displays requiring no glasses.

However, when seeing 3D images displayed based on the binocular parallax, the viewer may experience eye fatigue. In addition, a 3D image display providing left eye images and right eye images from only two viewpoints may not reflect variations in a viewpoint according to movement of the viewer, and thus, there is a limitation in providing a natural stereoscopic effect.

In order to display natural 3D images, holographic displays are being researched.

### SUMMARY

One or more exemplary embodiments may provide holographic displays having a viewing angle of 360°.

Additional aspects will be set forth in part in the description which follows and, in part, will be apparent from the description, or may be learned by practice of the presented exemplary embodiments.

According to an aspect of the exemplary embodiments, a holographic display comprises: a support plate which is configured to be rotatable based on a rotary axis; a plurality of spatial light modulators arranged on the support plate at same distances from the rotary axis; a light source configured to supply light to the plurality of spatial light modulators; an optical path conversion device configured to guide light emitted from the light source to the plurality of spatial light modulators; an image signal input device configured to input holographic image signals to the plurality of spatial light modulators; and an imaging area configured to display images generated by the plurality of spatial light modulators.

A through hole may be provided in the support plate around the rotary axis, the light source may be disposed under the through hole, and the optical path conversion unit may be disposed above the through hole.

The optical path conversion unit may have a conical shape.

The holographic display may further include a lens configured to collimate the light emitted from the light source between the light source and the optical path conversion device.

The plurality of spatial light modulators may be reflective-type spatial light modulators.

The optical path conversion device may be disposed between each of the plurality of spatial light modulators and the imaging area, and the light source may be disposed at a side of the optical path conversion device.

The optical path conversion device may be a light guide plate.

Each of the plurality of the spatial light modulators may have at least one of a one-dimensional array and a two-dimensional array structure.

Each of the spatial light modulators and the optical path conversion device may be located perpendicularly to the support plate.

Each of the spatial light modulators and the optical path conversion device may be disposed in a long direction with respect to the support plate.

The plurality of spatial light modulators may be disposed at different angles with respect to the rotary axis.

The plurality of spatial light modulators may modulate at least one of phase and amplitude of the light.

Each of the plurality of spatial light modulators may have a one-dimensional array or a two-dimensional array structure.

The holographic display may further include a support post for supporting each of the spatial light modulators.

The plurality of spatial light modulators may be arranged at constant intervals.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a schematic diagram of a holographic display according to an exemplary embodiment;

FIG. 2 is a partially cross-sectional view of the holographic display of FIG. 1;

FIG. 3 is a plan view of the holographic display of FIG. 1;

FIG. 4 is a diagram for describing operations of a holographic display according to an exemplary embodiment;

FIG. 5 is a diagram of a spatial light modulator included in a holographic display, according to an exemplary embodiment;

FIG. 6 is a cross-sectional view of the spatial light modulator of FIG. 5, taken along line A-A of FIG. 5;

FIG. 7 is a diagram of a holographic display according to another exemplary embodiment;

FIG. 8 is a schematic diagram of a holographic display according to another exemplary embodiment;

FIG. 9 is a plan view of the holographic display of FIG. 8; and

FIG. 10 is a partially cross-sectional view of the holographic display of FIG. 8.

### DETAILED DESCRIPTION OF EXEMPLARY EMBODIMENTS

Reference will now be made in detail to exemplary embodiments, examples of which are illustrated in the accompanying drawings, wherein like reference numerals refer to like elements throughout and sizes or thickness of elements may be exaggerated for clarity. In this regard, the present exemplary embodiments may have different forms and should not be construed as being limited to the descriptions set forth herein. When an element is “on” or “above” another element, the element may be directly on the other element or an intervening element may be present. Expressions such as “at least one of,” when preceding a list of elements, modify the entire list of elements and do not modify the individual elements of the list.

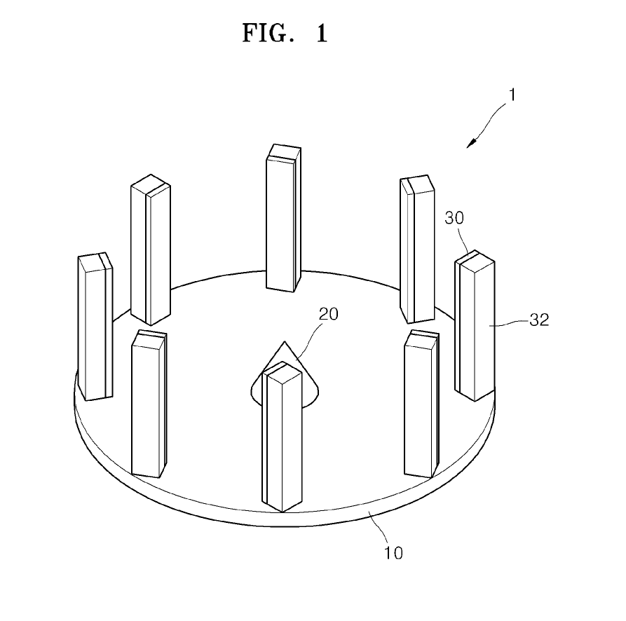

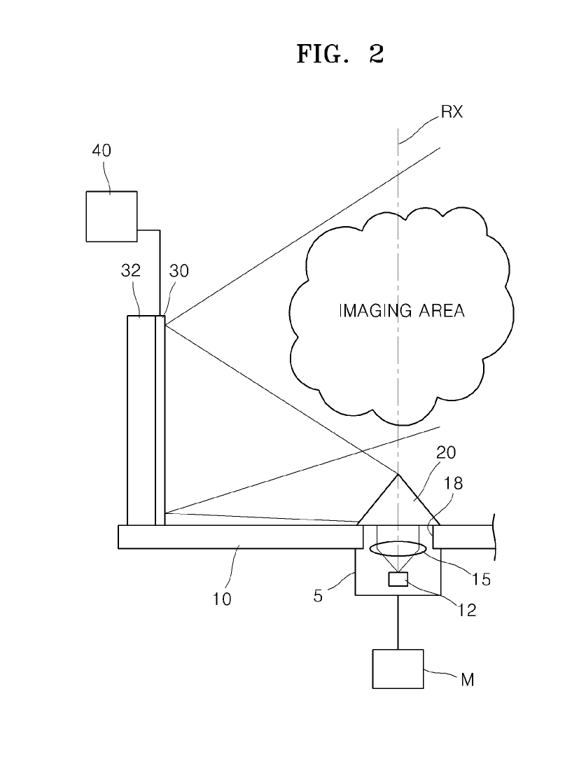

FIG. 1 is a schematic diagram of a holographic display 1 according to an exemplary embodiment, and FIG. 2 is a partially cross-sectional view of the holographic display 1. The holographic display 1 includes a support plate 10, a plurality of spatial light modulators 30 on the support plate 10, and a light source 12 supplying light to the plurality of spatial light modulators 30.

The support plate 10 is rotatable about a rotary axis RX by a motor M. The support plate 10 may be circular. However, exemplary embodiments are not limited thereto, and the support plate 10 may be, for example, polygonal.

The plurality of spatial light modulators 30 may be disposed at equal distances from the rotary axis RX. The plurality of spatial light modulators may be arranged on a coaxial circle based on the rotary axis RX at constant intervals therebetween. Support posts 32 may be further formed to respectively support the plurality of spatial light modulators 30. The spatial light modulators 30 may modulate at least one of a phase or an amplitude of light.

The light source 12 may supply light to the plurality of spatial light modulators 30. The light source 12 may be disposed under the support plate 10. An optical path conversion device 20 may be disposed to transmit light from the light source 12 to the spatial light modulators 30. The optical path conversion device 20 may be disposed on the rotary axis RX. The optical path conversion device 20 may have, for example, a conical shape. However, the shape of the optical path conversion device is not limited thereto. The optical path conversion device 20 may have, for example, a prism shape. A lens 15 for collimating light may be further disposed between the light source 12 and the optical path conversion device 20. A through-hole 18 may be provided in the support plate 10 based on the rotary axis RX. The light source 12 may be disposed under the through-hole 18. If the support plate 10 is transparent, the through-hole 18 may not be formed. In FIG. 1, the light source 12 is disposed under the support plate 10; however, the light source 12 may be disposed on the support plate 10. The light source 12 is mounted in a housing 5.

The light emitted from the light source 12 may be respectively irradiated to the plurality of spatial light modulators 30 through the optical path conversion device 20. Each of the spatial light modulators 30 may modulate the light according to an image signal input from an image signal input device 40 to display an image. The image signal input device 40 may generate, for example, a holographic image signal, and inputs the holographic image signal to the spatial light modulators 30. The holographic image signal may include, for example, a computer-generated hologram (CGH). When the light is incident to the spatial light modulators 30, a holographic image may be displayed according to the holographic image signal. Images generated by the plurality of spatial light modulators 30 may be displayed on an imaging area.

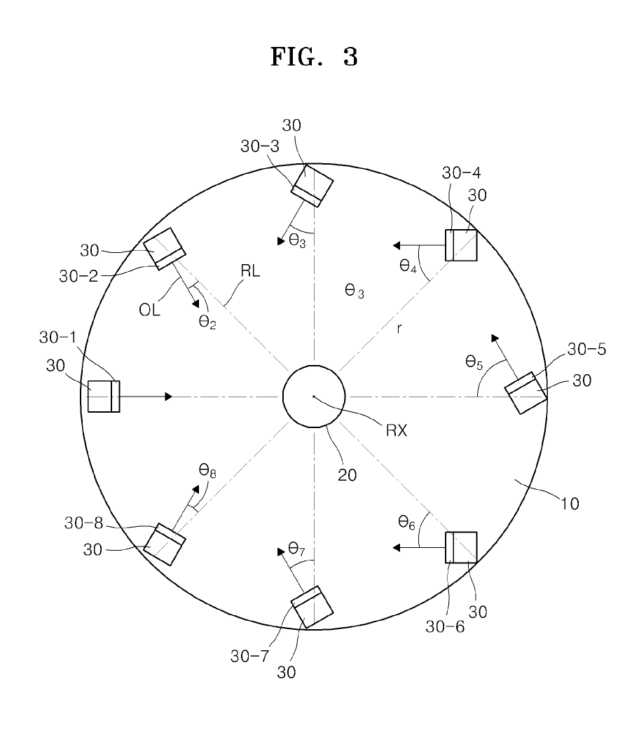

The plurality of spatial light modulators 30 may be arranged on the support plate 10 on a coaxial circle based on the rotary axis RX, as shown in FIG. 3. The spatial light modulators 30 may be arranged to have different light orientation directions. For example, the spatial light modulators 30 may be arranged at different angles with respect to the rotary axis.

Referring to FIG. 3, the plurality of spatial light modulators 30 may include, for example, first through eighth spatial light modulators 30-1, 30-2, 30-3, 30-4, 30-5, 30-6, 30-7, and 30-8. First through eighth angles θ1, θ2, θ3, θ4, θ5, θ6, θ7, and θ8 between first lines OL that are perpendicular to light exit surfaces of the first through eighth spatial light modulators 30-1, 30-2, 30-3, 30-4, 30-5, 30-6, 30-7, and 30-8, and second lines RL connecting centers of the first through eighth spatial light modulators 30-1, 30-2, 30-3, 30-4, 30-5, 30-6, 30-7, and 30-8 and the rotary axis RX, may be different. The first through eighth angles θ1, θ2, θ3, θ4, θ5, θ6, θ7, and θ8 are referred to as orientation angles of the first through eighth spatial light modulators 30-1, 30-2, 30-3, 30-4, 30-5, 30-6, 30-7, and 30-8. Here, the first angle θ1 may be 0°, and thus, FIG. 3 does not show the first angle θ1. The first through fifth angles θ1, θ2, θ3, θ4, and θ5 may be angles in a clockwise direction, and the sixth through eighth angles θ6, θ7, and θ8 may be angles in a counter-clockwise direction.

For example, the angle between the first line OL that is perpendicular to the light exit surface of the first spatial light modulator 30-1 and the second line RL connecting a center of the first spatial light modulator 30-1 and the rotary axis RX is 0°, and the angle between the first line OL that is perpendicular to the light exit surface of the second spatial light modulator 30-2 and the second line RL connecting a center of the second spatial light modulator 30-2 and the rotary axis RX may be θ2, which is greater than 0°. For example, the first through fifth angles may be θ1>θ2>θ3>θ4>θ5. In addition, the fourth angle θ4 and the sixth angle θ6 may be equal, the third angle θ3 and the seventh angle θ7 may be equal, and the second angle θ2 and the eighth angle θ8 may be equal. The first through eighth spatial light modulators 30-1, 30-2, 30-3, 30-4, 30-5, 30-6, 30-7, and 30-8 may display an image.

Operations of the holographic display 1 shown in FIG. 1 will be described below.

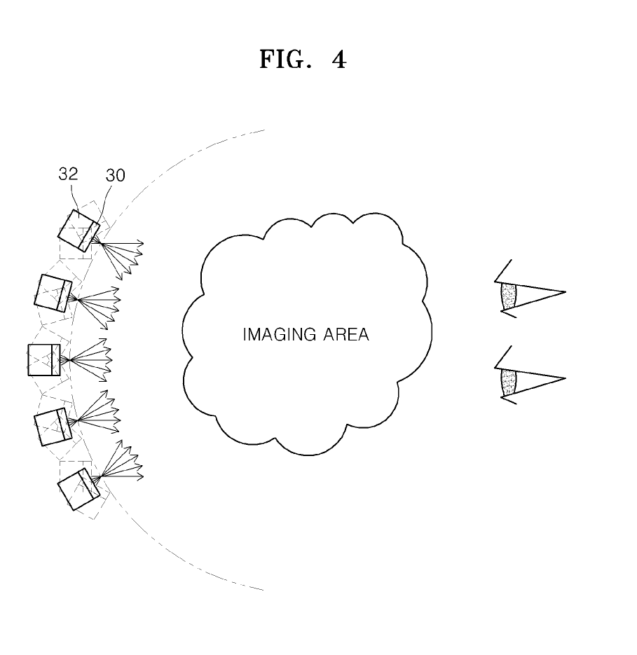

When the support plate 10 rotates, the first through eighth spatial light modulators 30-1, 30-2, 30-3, 30-4, 30-5, 30-6, 30-7, and 30-8 on the support plate 10 also rotate. As the first through eighth spatial light modulators 30-1, 30-2, 30-3, 30-4, 30-5, 30-6, 30-7, and 30-8 rotate, images generated by the first through eighth spatial light modulators 30-1, 30-2, 30-3, 30-4, 30-5, 30-6, 30-7, and 30-8 may be displayed on the imaging area from a plurality of viewpoints. For example, generation of the image at a first point where the first spatial light modulator 30-1 is located will be described with reference to FIG. 3. When the support plate 10 rotates, the first through eighth spatial light modulators 30-1, 30-2, 30-3, 30-4, 30-5, 30-6, 30-7, and 30-8 sequentially pass through the first point. When the first through eighth spatial light modulators 30-1, 30-2, 30-3, 30-4, 30-5, 30-6, 30-7, and 30-8 pass through the first point, the orientation directions of the first through eighth spatial light modulators 30-1, 30-2, 30-3, 30-4, 30-5, 30-6, 30-7, and 30-8 are different, and the first through eighth spatial light modulators 30-1, 30-2, 30-3, 30-4, 30-5, 30-6, 30-7, and 30-8 may display the image. The image displayed by the first through eighth spatial light modulators 30-1, 30-2, 30-3, 30-4, 30-5, 30-6, 30-7, and 30-8 may be a holographic image. Referring to FIG. 4, the first through eighth spatial light modulators 30-1, 30-2, 30-3, 30-4, 30-5, 30-6, 30-7, and 30-8 may display images at other points in the same manner as above, and directions of displaying images at the points may be different. Here, the points where the images are generated and the number of points may vary depending on a rotating speed of the support plate 10. As such, the images may be displayed in all directions, that is, a 360° angle, according to the rotation of the support plate 10. That is, the holographic display 1 according to the present exemplary embodiment may have a viewing angle of 360°.

A viewer may see a three-dimensional (3D) image displayed by the holographic display 1 from any direction around the holographic display 1.

A spatial light modulator used in the holographic display 1 according to the exemplary embodiment may be, for example, a micro electro mechanical systems (MEMS) actuator array, a ferroelectric liquid crystal spatial light modulator (FLC SLM), an acousto-optical modulator (AOM), and the like.

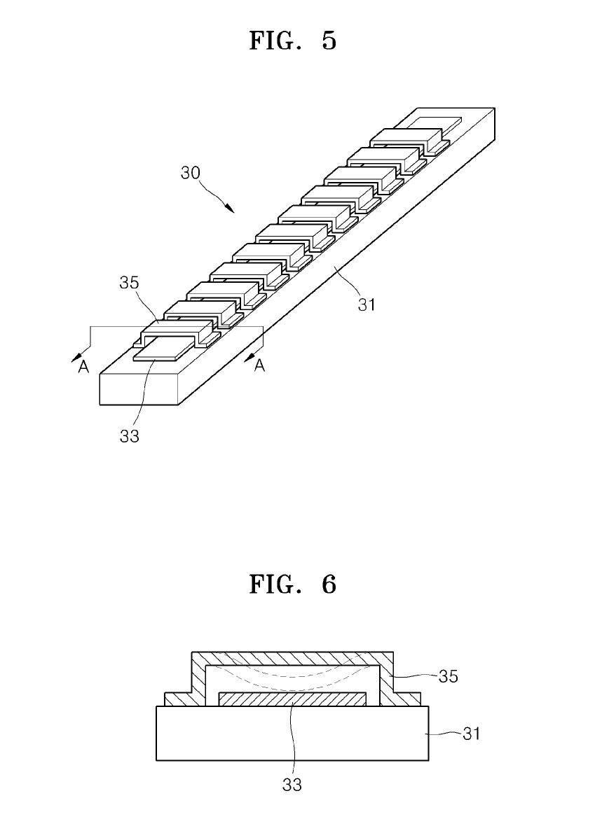

FIG. 5 is a diagram of an MEMS actuator array as an example of the spatial light modulator 30. The spatial light modulator 30 may include a substrate 31, a common electrode 33 disposed on the substrate 31, and a plurality of electrodes 35 disposed separately from each other on the common electrode 33. The plurality of electrodes 35 may be arranged apart from each other in a row along the common electrode 33. The electrodes 35 may be formed of a material that is flexible and reflects light.

When voltages are applied to the common electrode 33 and the electrodes 35, electric attraction occurs between the common electrode 33 and the electrodes 35, and thus, the electrodes 35 may be pulled toward the common electrode 33, as shown in FIG. 6. Then, upper surfaces of the electrodes 35 are transformed, and directions of light reflected by the electrodes 35 may be changed.

The spatial light modulator 30 shown in FIGS. 5 and 6 is an example, and the spatial light modulator 300 may be modified in various manners.

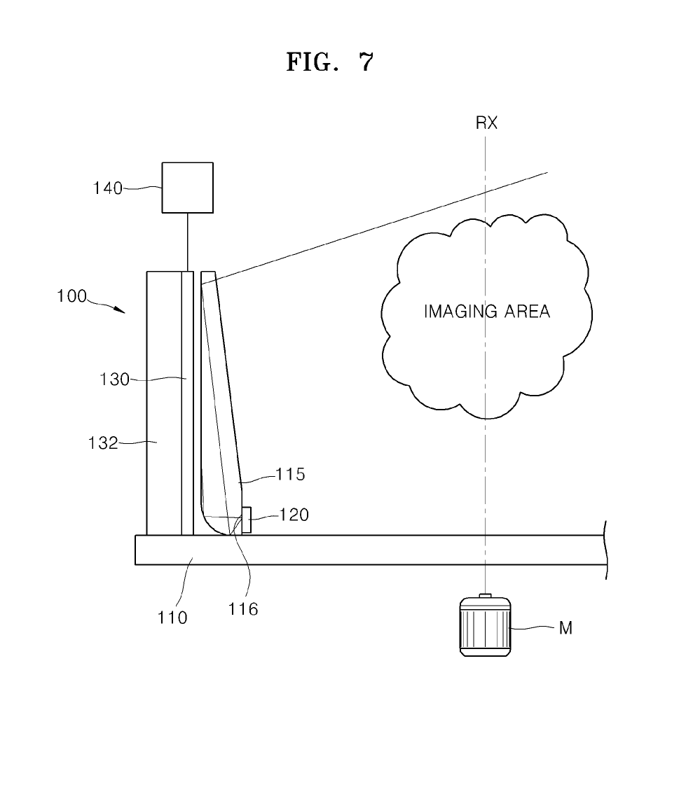

FIG. 7 is a partially cross-sectional view of holographic display 100 according to another exemplary embodiment.

The holographic display 100 includes a support plate 110, a plurality of spatial light modulators 130 on the support plate 110, and a light source 120 supplying light to the plurality of spatial light modulators 130. The support plate 110 may be rotated based on a rotary axis RX by a motor M. The plurality of spatial light modulators 130 may be arranged at the same distances from the rotary axis RX on the support plate 110. In addition, the plurality of spatial light modulators 130 may be arranged on a coaxial circle based on the rotary axis RX at the same intervals therebetween. The spatial light modulators 130 may be arranged to have different orientation directions on the support plate 110 (refer to FIGS. 1 and 3).

The spatial light modulators 130 may be supported by support posts 132. The light source 120 may irradiate light to each of the spatial light modulators 130. An optical path conversion device 115 may be disposed to guide the light emitted from the light source 120 to the spatial light modulator 130. The optical path conversion device 115 may be disposed, for example, between the light source 120 and the spatial light modulator 130. The optical path conversion device 115 may be, for example, a light guide tube. The optical path conversion device 115 has an incidence surface 116 to which the light emitted from the light source 120 is incident. The light may be partially reflected on the optical path conversion device 115, and may be partially discharged to the spatial light modulator 130. The optical path conversion device 115 may be, for example, a wedge-type light guide plate. The incidence surface 116 of the optical path conversion device 115 may have a width that is greater than that of an opposite surface.

The light emitted from the light source 120 is incident to the spatial light modulator 130 via the optical path conversion device 115, and the light modulated by the spatial light modulator 130 may be displayed on an imaging area after passing through the optical path conversion device 115. An image signal is input to the spatial light modulator 130 from an image signal input device 140, and the light incident to the spatial light modulator 130 may be modulated according to the image signal.

The spatial light modulator 130 may include, for example, an MEMS actuator array, an FLC SLM, or an AOM. The spatial light modulator 130 may be a reflective-type modulator.

By comparing the holographic display 100 shown in FIG. 7 with the holographic display 1 of FIG. 1, the holographic display 100 is different from the holographic display 1 in that a light source is disposed to correspond to each of the spatial light modulators. Other components in the holographic display 100 are substantially the same as those of the holographic display 1 shown in FIG. 1, and thus, detailed descriptions thereof are not provided here.

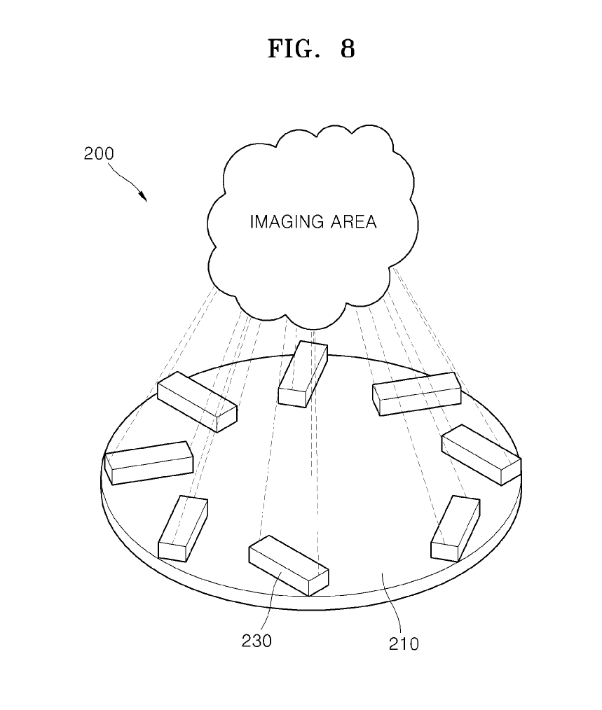

FIG. 8 is a schematic diagram of a holographic display 200 according to another exemplary embodiment. The holographic display 200 includes a rotatable support plate 210 and a plurality of spatial light modulators 230 arranged on the support plate 210. The support plate 210 is rotated based on the rotary axis RX. The spatial light modulator 230 may be formed as, for example, a rectangular parallelepiped, and may be arranged in a long direction with respect to the support plate 210. That is, the spatial light modulator 130 is disposed with its long axis perpendicular to the support plate 110 in FIG. 1, while the spatial light modulator 230 is disposed with its long axis in parallel with the support plate 210 in FIG. 8.

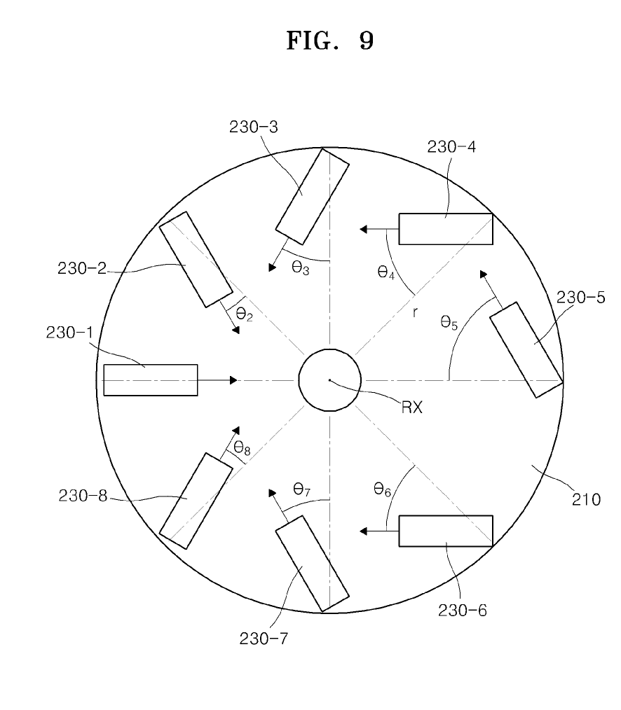

The plurality of spatial light modulators 230 may include first through eighth spatial light modulators 230-1, 230-2, 230-3, 230-4, 230-5, 230-6, 230-7, and 230-8. In addition, the first through eighth spatial light modulators 230-1, 230-2, 230-3, 230-4, 230-5, 230-6, 230-7, and 230-8 may be arranged at different angles with respect to the rotary axis RX. That is, angles between lines toward the rotary axis RX and lines in longitudinal directions of the spatial light modulators 230-1, 230-2, 230-3, 230-4, 230-5, 230-6, 230-7, and 230-8, that is, first through eighth angles θ1, θ2, θ3, θ4, θ5, θ6, θ7, and θ8, are different. The first through fifth angles θ1, θ2, θ3, θ4, and θ5 are angles in a clockwise direction, and the sixth through eighth angles θ6, θ7, and θ8 are angles in a counter-clockwise direction. Thus, the first through eighth angles θ1, θ2, θ3, θ4, θ5, θ6, θ7, and θ8 shown in FIG. 9 are different.

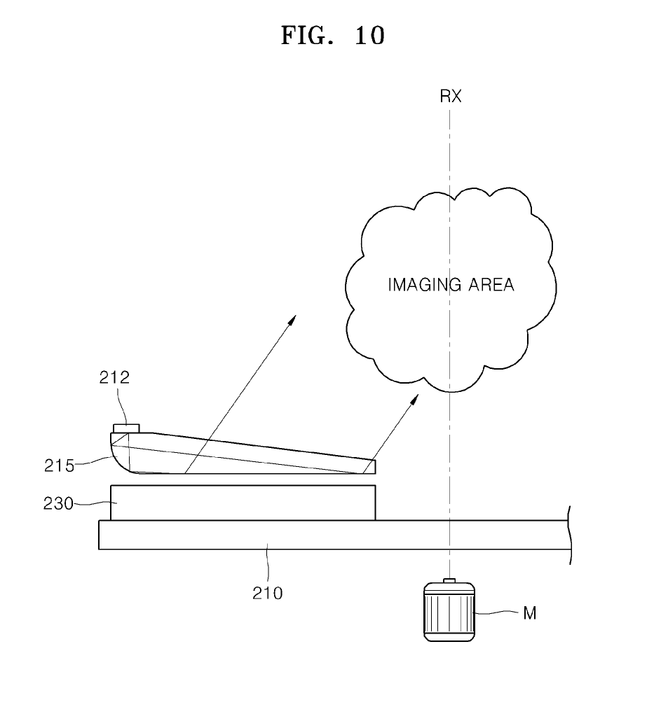

Referring to FIG. 10, an optical path conversion device 215 may be disposed on the spatial light modulator 230. In FIGS. 8 and 9, arrangements of the spatial light modulators 230 are schematically shown, and a light source 212 and the optical path conversion device 215 are omitted for convenience of description. The light source 212 may be disposed at a side of the optical path conversion device 215. The optical path conversion device 215 may be formed as a wedge-type, a thickness of which decreases from a side far from the rotary axis RX toward the rotary axis RX. For example, the light source 212 may be disposed at the side of the optical path conversion device 215, which is far from the rotary axis RX.

The light emitted from the light source 212 is incident to the spatial light modulator 230 via the optical path conversion device 215, and the light modulated in the spatial light modulator 230 is reflected to be displayed on an imaging area via the spatial light modulator 230. When the support plate 210 is rotated, the plurality of spatial light modulators 230 cooperate with each other to display a holographic image that may be displayed in all directions, that is, a 360° angle.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the exemplary embodiment as defined by the following claims.

What is claimed is:

1. A holographic display comprising:
a support plate which is configured to be rotatable based on a rotary axis;
a plurality of spatial light modulators configured to be arranged on the support plate at same distances from the rotary axis;
a light source configured to emit light to the plurality of spatial light modulators;
an optical path conversion device configured to guide light emitted from the light source to the plurality of spatial light modulators;
an image signal input device configured to input holographic image signals to the plurality of spatial light modulators; and
an imaging area on which images generated by the plurality of spatial light modulators are displayed.

2. The holographic display of claim 1, wherein a through-hole is provided in the support plate around the rotary axis, the light source is disposed under the through-hole, and the optical path conversion device is disposed above the through-hole.

3. The holographic display of claim 2, wherein the optical path conversion device has a conical shape.

4. The holographic display of claim 2, further comprising a lens configured to collimate the light emitted from the light source between the light source and the optical path conversion device.

5. The holographic display of claim 1, wherein the plurality of spatial light modulators are reflective-type spatial light modulators.

6. The holographic display of claim 1, wherein the optical path conversion device is disposed between each of the plurality of spatial light modulators and the imaging area, and the light source is disposed at a side of the optical path conversion device.

7. The holographic display of claim 6, wherein the optical path conversion device is a light guide plate.

8. The holographic display of claim 6, wherein each of the plurality of the spatial light modulators has at least one of a one-dimensional array structure and a two-dimensional array structure.

9. The holographic display of claim 8, wherein each of the spatial light modulators and the optical path conversion device are disposed perpendicularly to the support plate.

10. The holographic display of claim 8, wherein each of the spatial light modulators and the optical path conversion device are disposed in a long direction with respect to the support plate.

11. The holographic display of claim 6, wherein the plurality of spatial light modulators are disposed at different angles with respect to the rotary axis.

12. The holographic display of claim 6, wherein the plurality of spatial light modulators modulate at least one of a phase and an amplitude of the light.

13. The holographic display of claim 1, wherein each of the plurality of spatial light modulators has at least one of a one-dimensional array structure and a two-dimensional array structure.

14. The holographic display of claim 13, wherein each of the spatial light modulators is disposed perpendicularly to the support plate.

15. The holographic display of claim 13, wherein the plurality of spatial light modulators modulate at least one of a phase and an amplitude of the light.

16. The holographic display of claim 1, further comprising a support post for supporting each of the plurality of spatial light modulators.

17. The holographic display of claim 1, wherein the plurality of spatial light modulators are arranged at constant intervals.

18. The holographic display of claim 1, wherein each of the plurality of spatial light modulators comprises at least one of a micro electro mechanical systems (MEMS) actuator array, a ferroelectric liquid crystal spatial light modulator (FLC SLM), or an acousto-optical modulator (AOM).

19. A holographic display comprising:
a plurality of spatial light modulators arranged to have different light orientation directions;
a rotatable support plate which supports the plurality of spatial light modulators;
a light source which is configured to emit light to the plurality of spatial light modulators
an optical path conversion device which is disposed between the light source and the plurality of spatial light modulators;
an image signal input device for inputting holographic image signals to the plurality of spatial light modulators, and
an imaging area for displaying images generated by the plurality of spatial light modulators.

20. The holographic display of claim 19, wherein the support plate is rotatable around a rotary axis.
